(19) United States
(12) Patent Application Publication
(10) Pub. No.: US 2013/0331995 A1
(43) Pub. Date: Dec. 12, 2013

(54) Thermostat with Selectable Embedded Preprogrammed Energy Savings Profiles

(71) Applicant: Howard Rosen, Wentworth-Nord (CA)

(72) Inventor: Howard Rosen, Wentworth-Nord (CA)

(21) Appl. No.: 13/492,678

(22) Filed: Jun. 8, 2012

(51) Int. Cl. G05B 15/02

(52) U.S. Cl. 700/276

(57) ABSTRACT

A method and/or apparatus providing for an improved user interface for controlling a complex thermostat or Energy Management System is disclosed. The invention provides for a user selection of an energy management profile from a number of preconfigured stored profiles, the selection of the profile by the user then providing setting or control of many complex control settings for an energy management system or thermostat. The profiles can be labelled and/or ordered in levels or percentages of energy savings, and/or given names meaningful in making a selection.

### CROSS REFERENCE TO RELATED APPLICATIONS

This application claims priority to a United States Provisional patent application filed Jun. 9, 2011 titled “Thermostat with Selectable Embedded Preprogrammed Energy Savings Profiles” by inventor Howard Rosen, which is expressly incorporated herein as though set forth in full.

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

The present invention relates to Heating Ventilation and Air Conditioning (HVAC) systems, improving operation of these systems, and providing for improvements in the methods, and/or algorithms used in the management of energy used by these HVAC systems. The present invention relates to the art of improving and simplifying the configuration of energy saving thermostats.

There are many energy saving thermostats currently in use in hospitality and large multi-room complexes, some of these thermostats may be connected to a network and in some instances may include occupancy sensors which detect the presence of an occupant and adjust the thermostat based on condition of occupancy or non-occupancy.

Typical energy saving thermostats include many configurable settings which provide for the fine tuning of the energy saving with a goal of not significantly affecting the guest or occupants comfort experience. For example, an energy management thermostat may include more than one adjustable setting to optimize the performance with regards to guest comfort and percentage of energy saved. The addition of occupancy sensors are an example of a control consideration that has potential for greatly complicating energy management control algorithms, and increasing the number of settings which might be necessary for a user to configure to achieve improved energy savings, or improved comfort.

As the number of options required to configure an energy management system increases it becomes harder and harder for an end user to configure the system, and also potentially harder to even achieve energy savings because of the complex interaction between settings and options. Indeed, experiments and collection of data by experts may provide greater insight into what might be an improved energy savings plan than what might be achievable by a typical end user. It would therefore be an improvement if an energy management system can be provided with both an improved user interface, and with improved energy savings by simplifying selection of an energy management setting profile.

### BRIEF SUMMARY OF THE INVENTION

This application incorporates by reference the United States Provisional patent application filed Jun. 9, 2011 titled “Thermostat with Selectable Embedded Preprogrammed Energy Savings Profiles” by inventor Howard Rosen.

Below is an example of energy saving options that may be configurable in energy saving thermostats. This list is for reference only and may be different for various models of thermostats. It is noted that the relatively large number of settings to be controlled is typical of energy savings thermostats that are designed to achieve the most savings while still maintaining comfort. It is noted that control setting “values” may be settings such as “auto”, “on”, or “off” or similar phrases which distinguish between a few choices.

Example of Energy Saving Option Operations:

### 1) First Select TEMPERATURE CONTROL MODE:

a. AUTO—Automatically turns on heating or air conditioning to maintain the room temperature at the selected temperature setpoint;
b. MANUAL—Allows users to select COOL or HEAT temperature control mode to maintain the room temperature below or above the selected temperature setpoint;

### 2) Next Select FAN OPERATION MODE:

a. CONTINUOUS—fan runs continuously unless the thermostat is turned off;
b. AUTOMATIC—fan runs only when there is a demand for heating or air conditioning;
   3) Next select MINIMUM SETPOINT value:
Select the minimum setpoint in ° F. or ° C. ° F. or ° C. or ° C. that a guest can select
   4) Next select MAXIMUM SETPOINT value:
Select the maximum setpoint in ° F. or ° C. that a guest can select.
   5) Next select DEADBAND value:
Select the difference between the heat and cool setpoint in the Automatic Temperature mode (i.e. 1a.)
The minimum difference between heat and cool setpoint allows avoiding excessive use of the compressor
   6) Next select 1ST STAGE DIFFERENTIAL—HEAT value:
Select the difference between temperature setpoint and room temperature before 1st stage heating is initiated.
   7) Next select 2ND STAGE DIFFERENTIAL—HEAT value:
Select the difference between 1st Stage Heating and 2nd Stage Heating initiation.
   8) Next select 1ST STAGE DIFFERENTIAL—COOL value:
Select the difference between temperature setpoint and room temperature before 1st stage cooling is initiated
   9) Next select FORCE 2ND STAGE HEATING AFTER value:
Select a number of minutes that compressor will run before Heat Strip is turned on to help raise the temperature when the temperature setpoint is not reached using the Heat Pump only and Heat Strip is not turned on through stage differential settings.
   10) Next select TEMPERATURE RECOVERY TIME value:
Select the maximum time allowed for a HVAC unit to attain temperature as defined by HEAT and COOL RECOVERY TEMPERATURE;
The Thermostat uses the Temperature Recovery Time selected here and the temperature recovery rate of the HVAC unit in the room to calculate the setback temperature in order to maximize the energy saving while at the same time ensuring that a comfortable room temperature defined as HEAT and COOL RECOVERY TEMPERATURE will be restored within the selected Temperature Recovery Time.
The Temperature Recovery Time can be set to disabled as discussed herein.
   11) Next select RECOVERY TEMPERATURE—COOL value:
Select the room temperature in ° F. or ° C. that a HVAC unit will have to attain within the selected Temperature Recovery Time when there is a need to cool the room.
   12) Next select RECOVERY TEMPERATURE—HEAT value:
Select the room temperature in ° F. or ° C. that a HVAC unit will have to attain within the selected Temperature Recovery Time when there is a need to heat the room.
   13) Next select MAXIMUM SETBACK TEMPERATURE value:
Select the Maximum Setback Temperature in ° F. or ° C.
Setback temperature is calculated by measuring HVAC unit's ability to attain “Recovery Temperature—Cool” within “Temperature Recovery Time”.
If recovery is disabled (“Temperature Recovery Time” is set to “Disabled”) or if setback temperatures have not yet been calculated, the “Maximum Setback Temperature” value will be used as the setback temperature for cooling.
If calculated setback temperature for air conditioning is higher than “Maximum Setback Temperature”, then the “Maximum Setback Temperature” will be used as a setback temperature for air conditioning.
This feature allows defining the maximum temperature in a room when room is unoccupied and the thermostat is in the setback mode.
   14) Next Select MINIMUM SETBACK TEMPERATURE value:
Select the Minimum Setback Temperature in ° F. or ° C.
Setback temperature is calculated by measuring HVAC unit's ability to attain “Recovery Temperature—Heat” within “Temperature Recovery Time”.
If recovery is disabled (“Temperature Recovery Time” is set to “Disabled”) or if setback temperatures have not yet been calculated, the “Minimum Setback Temperature” value will be used as the setback temperature for heating.
If calculated setback temperature for heating is lower than “Minimum Setback Temperature”, then the “Minimum Setback Temperature” will be used as a setback temperature for heating.
This feature allows defining the minimum temperature in a room when room is unoccupied and the thermostat is in the setback mode.
   15) Select TEMPERATURE SETBACK DELAY—COOL value:
Select the time delay before the thermostat will initiate the temperature setback and allow the room temperature to rise to the setback temperature after the room becomes unoccupied
This feature prevents initiating temperature setback prematurely while the guest is still in the room but in an area where occupancy cannot be detected by the occupancy sensor.
   16) Select TEMPERATURE SETBACK DELAY—HEAT value:
Select the time delay before the thermostat will initiate the temperature setback and allow the room temperature to drop to the heat setback temperature after the room becomes unoccupied.
This feature prevents initiating temperature setback prematurely while the guest is still in the room but in an area where occupancy cannot be detected by the occupancy sensor.
   17) Select SHORT OCCUPANCY THRESHOLD value:
Select a minimum period of time for which occupancy needs to be detected in order to consider the room occupied.
When occupancy is detected while the room is considered unoccupied, the thermostat will instantaneously switch to occupied mode. However, if occupancy is detected only for a period of time shorter than the short occupancy threshold selected here, the thermostat will automatically revert to unoccupied mode and continue to observe energy saving functions that were in effect before the room became occupied.
This setting allows ignoring incidental room visits.
   18) Select NIGHT OCCUPANCY THRESHOLD value:
Select a minimum period of time for which occupancy needs to be detected in order to consider the room occupied during the Night Occupancy.
When occupancy is detected while the room is considered unoccupied during the Night Occupancy period, the thermostat will instantaneously switch to occupied mode.
If occupancy is detected only for a period of time shorter than the night occupancy threshold selected here, the thermostat will automatically revert to unoccupied mode and continue to observe energy saving functions that were in effect before the room became occupied.
If occupancy is detected for a period of time longer than the night occupancy threshold selected here, the thermostat will disable the occupancy sensor and consider the room occupied until the end of the night occupancy period.
This feature ensures that energy saving functions that may affect guest comfort will not come into effect during the night occupancy period if at least one room occupancy exceeding the night occupancy threshold was registered during the night occupancy period.
   19) Select NIGHT OCCUPANCY START value:
Select the start time for Night Occupancy.
If during the Night Occupancy period, occupancy is detected for a period of time longer than the night occupancy threshold, the thermostat will disable the occupancy sensor and consider the room occupied until the end of the night occupancy period.
This setting allows defining a time period during which energy saving functions that may affect guest comfort will not come into effect if at least one room occupancy exceeding the night occupancy threshold was detected.
   20) Select NIGHT OCCUPANCY END value:
Select the end time for Night Occupancy.
If during the Night Occupancy period, occupancy is detected for a period of time longer than the night occupancy threshold, the thermostat will disable the occupancy sensor and consider the room occupied until the end of the night occupancy period.
This setting allows for defining a time period during which energy saving functions that may affect guest comfort will not come into effect if at least one room occupancy exceeding the night occupancy threshold was detected.

### 21) Select Configuration Option AUTO RESTORE:

1. ON—Thermostat automatically restores guest settings when occupancy is detected;
2. OFF—When occupancy is detected (after the room was unoccupied), the thermostat remains turned off—guest will have to turn on the thermostat to control the room temperature;

### 22) Select Configuration Option SETBACK SETPOINTS:

1. ON—When room is unoccupied, the thermostat maintains the room temperature between heat and cool setback temperatures;
2. OFF—When room is unoccupied, the thermostat does not control the temperature except to maintain the freeze protection—temperature above 40° F. or ° C. (4.5° C.);

As one can see from examining the 22 exemplary settings listed above, proper configuration of an energy saving thermostat is potentially a tedious and/or complex task and would typically require a skilled person who is experienced in the art of configuring the thermostat to achieve a productive quantity of energy saving while maintaining the comfort of the occupant. In fact, even an expert with experience might need to experiment and possibly determine empirically what might be the best set of inter-related choices and settings to be made in achieving the best energy management savings while maintaining reasonable “comfort” in a conditioned space. The twenty-two settings illustrated above are certainly a significant number of necessary settings to step through for a user, and especially so for a potentially unskilled user. In fact, even a smaller number of settings such as five or ten can be a significant number for a user since the settings may interact with each other and possibly not produce desired results with a first try.

It is therefore an important advantage to provide a means whereby a less skilled person, or even an almost completely unskilled user, would be capable of effectively configuring the energy saving thermostat, thus providing for taking less time in programming and more importantly so that the energy savings can be achieved with less background knowledge and/or training. It is also an advantage if the selection of settings is based upon prior measurements and experimental data from the field, that is, trying various combinations of settings and seeing what works. It may also be an advantage to base the settings upon seasons of the year, climate, zip code or location and other such factors.

Therefore, settings such as the exemplary settings above have been placed in a table in the thermostat or energy management system's memory and preconfigured to specify more than one predetermined group of settings. The group of settings can be determined or selected such that each group provides for a degree or percentage or “level of aggressiveness” of potential energy savings. A group of settings can also be used to provide for maximum comfort or styles of management which achieve various types of comfort. For example, a group of settings that is appropriate for comfort in the winter when heating is required may be quite different than those most beneficial to savings or comfort when cooling is required.

Similarly, a group of settings for one zip code or geographic area, or time of the year, or outside temperature may be different than that when these exemplary considerations are different.

For example, in one embodiment, an energy saving thermostat or energy management system can provide a simple selectable menu provided on a user interface included within the thermostat displaying/containing different levels of energy saving. In the example below and for demonstration purposes only, the levels have been preconfigured to provide increasing energy savings as specified by the order of the level number. The selection of items from a menu might also be done over a network as will be readily appreciated by those skilled in the art.

For example, Level 0 could be selected to disable all energy saving features of the system/equipment, and allow the thermostat to function as a conventional or basic thermostat. Level 1 when selected could allow the thermostat to include occupancy detection and time of day enabling one to modify certain occupancy features. Level 3 through level 5 could be used to increase the ability of the HVAC system to save energy by adjusting the 22 settings above by simply entering the level number using the thermostat menu screen. By no means is it necessary to use level numbers as they can be represented by letters or words to describe the level of aggressiveness or “aggressivity” of the energy saving setting. The major or primary objective of the present invention is to simplify the process of establishing the settings configuration by just requiring the calling up a lookup table that corresponds to the desired energy saving configuration.

It should be noted with regard to the number and complexity of energy management control features that the inclusion of information provided by occupancy sensors in one or more the conditioned spaces served by an HVAC system/energy management system typically will increase the number and the complexity of the energy management features in comparison to the number and complexity of features that might typically be considered by a system with no occupancy based controls.

Occupancy based energy control features have potential for greatly increasing savings based up whether or not a room is occupied, has been recently occupied, is currently occupied or about to be occupied. Determining periods of anticipation of occupancy, periods of possible return of an occupant, and controlling of occupancy based energy control based upon the time of day, or even the season of the year, or outside temperature has potential for making the programming of the energy management system very, very complex. This is one reason why having predetermined profiles which have been defined based upon empirical data, or the experience of an expert has potential for achieving more energy savings with less programming than what might be achieved by asking an end user to try and guess at a “best” setting through selection of lots of inter-related settings and features.

Occupancy is a good example for the purpose of illustration, but it is not the only added input which has potential for greatly complicating the determining of the most beneficial settings and algorithms for the control of energy management features. Data relating to end user preferences, typical arrival times, typical departure times, the outside temperature, the weather forecast, and other similar data all have potential for consideration in reducing energy costs by determining or affecting the specifics of controlling an HVAC system or in selecting an energy management plan or strategy of control.

### BRIEF DESCRIPTION OF THE SEVERAL VIEWS OF THE DRAWING

The invention will be better understood by means of the following description, given only as an example and in reference to the attached drawings. Other advantages, purposes and characteristics of the present invention will emerge from the following detailed description and with reference to the attached drawings, in which:

FIG. 1 illustrates a number of exemplary energy management or thermostat control settings “profiles” including the settings for a significant number of energy savings options illustrated with exemplary values for several “levels” of intended energy savings;

FIG. 2 illustrates a menu screen provided by a selection apparatus, possibly part of a thermostat screen presentation, or utilizing a web browser interface, the menu screen providing a simple way for a user to select a level of energy savings, trading off against “comfort” without having to understand the details of a significant number of settings which are actually specified by selecting a specific profile or level of savings; and,

FIG. 3 is an exemplary block diagram of an energy management system incorporating the present invention.

### DETAILED DESCRIPTION OF THE INVENTION

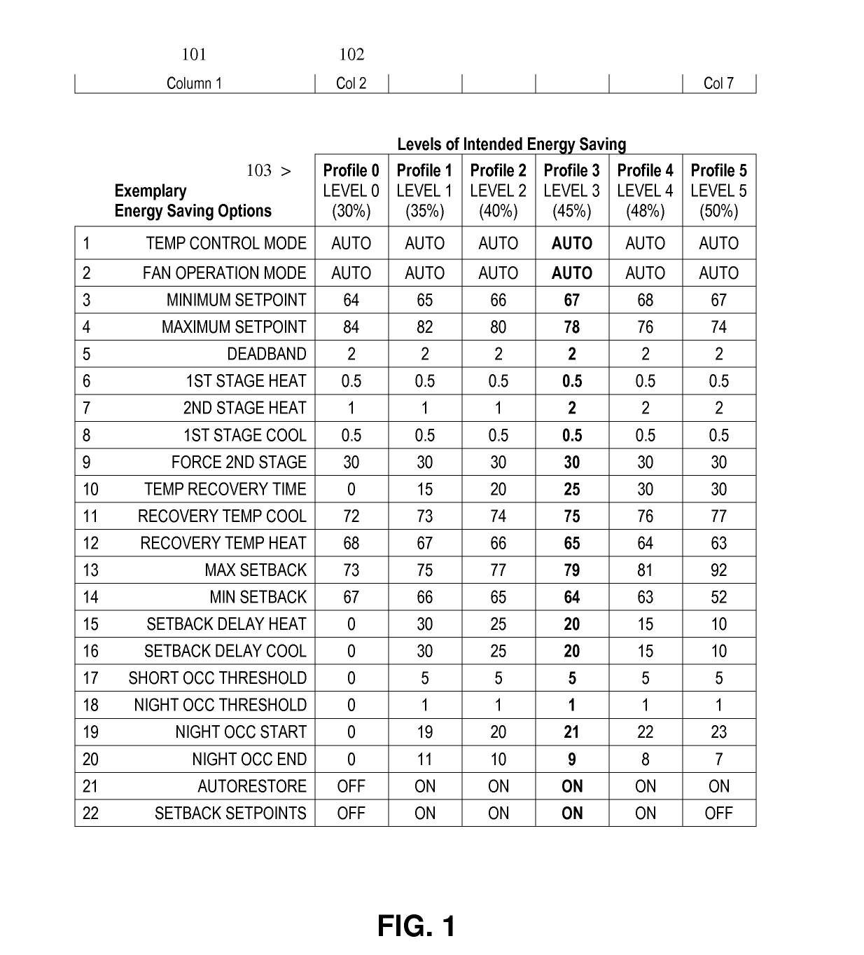

An exemplary table including examples of selectable energy savings options which may typically be utilized by an energy management control program in controlling an HVAC system are shown in FIG. 1. FIG. 1 shows a list of options in rows of a table, having a first column 101 at the far left describing the control option and each row having a brief description of the option. The further columns to the right 102 illustrate a plurality of “profiles” that providing specific or actual settings, or ranges of settings for each control option.

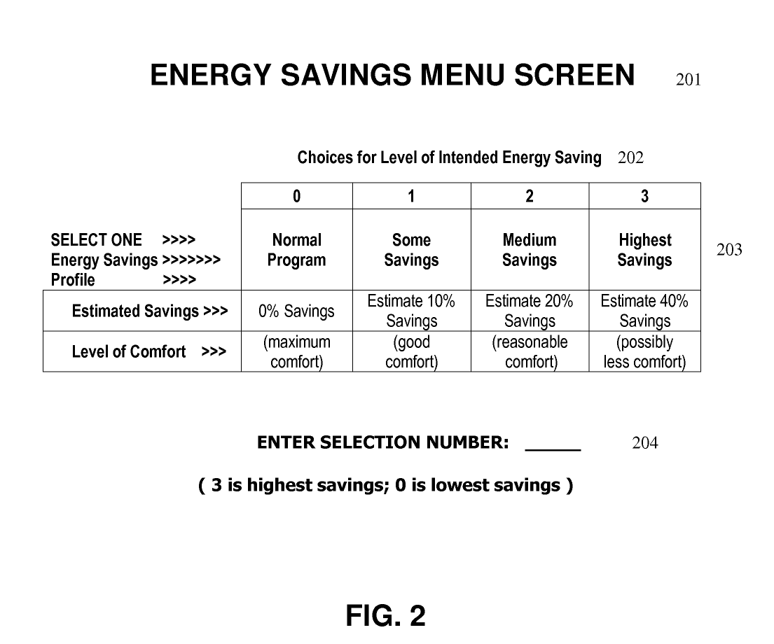

FIG. 2 is an illustration of a typical simplified user-interface that may be presented to a user for selection of an energy management profile, or a set of energy management values. An Energy Savings Menu Screen 201 presents a user with a mechanism to make a selection of one “profile” from four choices for a level of energy savings. The choices 202 are numbered from zero to three, and given “labels” 203 to briefly describe the intended goal of each “profile”. The user is asked to type a selection (from one to zero) in a selection number entry field 204.

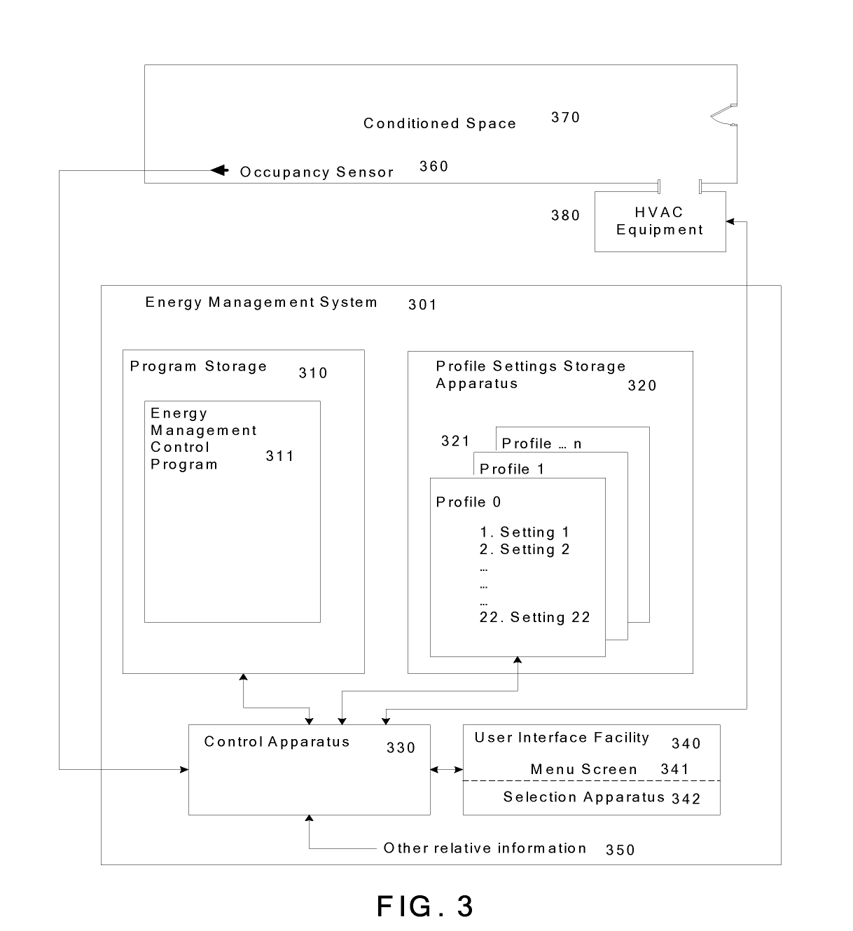

FIG. 3 is an exemplary block diagram of an energy management system incorporating the present invention. An energy management system 301 is controlling a piece of HVAC equipment 380. The HVAC equipment is for cooling (or heating) a conditioned space 370 (such as a room, multiple rooms, or areas).

The energy management system 301 which may be a thermostat or other similar device includes a control apparatus 330, the control apparatus typically being a micro-computer under control of an energy management control program 311 stored in a program storage memory 310. The program storage memory may be RAM, ROM, or RAM loaded from other storage as may be determined by those skilled in the art. A second storage area is provided, which may also be ROM, or disk or other permanent or semi-permanent storage 320 is utilized to store a number of “profiles” 321. Each profile 321 includes values for setting or controlling a significant number of features of the energy management system, those features typically incorporated in the energy management control program 311. The features of the energy management program are controlled by “settings”, the values of those settings potentially being different in the plurality of stored profiles. A set or group of settings (a profile) specify all, or at least most, of the settings of the thermostat (or energy management system) and these settings are utilized by the control program to “run” and control the HVAC system (Heating Ventilation and Air Conditioning System).

A user interface facility 340 provides a selection apparatus 342 for a user to make a selection, the selection apparatus perhaps utilizing a menu screen 341 on the thermostat, or maybe utilizing a web browser interface.

The settings specified by the selected profile may have complex inter-relationships. For example, deciding when to use second stage heat or cool when a user has just entered a room would also depend on the min and max setback temperatures.

The user thus is provided with a simplified way to choose a desired level of energy savings, possibly with some sacrifice in “comfort” to those people occupying a room. The user is saved from having to select and determine many, many settings, some of which the user may not even be able to understand. The selected profile specifies all those things for the user, with labels or names of the profiles describing in an understandable way the intended objective of the underlying group of settings.

Other information 350 may also be useful in selecting a profile. A user may indicate a level of energy savings desired, with more than of the profiles having that level of predicted savings. Such other information may include information such as zip code or geographic area, or time of year may also be factored into the determination of precisely which profile is to be applied. The selection of a profile may also change based upon other relevant information after an initial choice has been made.

It may also be useful for specific settings utilized in controlling the HVAC equipment by utilizing information from more than one profile. For example, if a user specifies that he or she wants 42% energy savings, and no profile exists for precisely that percentage, then the control program could interpolate between two or more profiles, or perhaps at least choose the energy savings profile with the closest match.

What is claimed is:

1. An energy management system for controlling Heating Ventilation and Cooling equipment serving at least one conditioned space, the system comprising:
A) at least one occupancy sensor for detecting occupancy in the conditioned space;
B) a program storage memory apparatus for storing an energy management control program used in controlling operation of the Heating Ventilation and Cooling equipment;
C) a control apparatus operatively coupled to the program storage memory apparatus and running under control of the energy management control program for controlling operation of the Heating Ventilation and Cooling equipment;
D) a settings storage apparatus storing a plurality of preconfigured energy management profiles, each preconfigured energy management profile including a significant number of energy management feature control setting values;
E) a selection apparatus enabling a user of the energy management system to select at least one selected energy management profile to be applied for use by the energy management control program; and,
F) the control apparatus being responsive to the control program for controlling the Heating Ventilation and Cooling equipment in accordance with the selected preconfigured energy management profile wherein at least one of the energy management features in the selected profile controlled is based upon output obtained from the occupancy sensor.

2. The energy management system of claim 1) wherein the number of preconfigured energy management profiles is five or more.

3. The energy management system of claim 1) wherein the number of preconfigured energy management profiles is eight or more.

4. The energy management system of claim 1) wherein the selection of the preconfigured energy management profile is facilitated by utilizing labels or names of the profile that identify to a user a degree of aggressiveness in achieving energy savings.

5. The energy management system of claim 1) wherein the selection of the preconfigured energy management profile is facilitated by presenting the profiles for selection according to a percentage or amount of estimated energy savings.

6. The energy management system of claim 1) wherein the selection apparatus generates a menu screen for displaying a listing of the preconfigured energy management profiles.

7. The energy management system of claim 1) wherein the selection apparatus generates a menu screen for displaying a listing of labels for each of the preconfigured energy management profiles, and the labels briefly describe a goal or purpose for each preconfigured energy management profile.

8. The energy management system of claim 1) wherein the selection apparatus utilizes other potentially relative information, such as geographic area, in determining the selection of the selected preconfigured energy management profile.

9. The energy management system of claim 1) wherein the selection apparatus enables choosing the selected energy management profile based upon user input specifying a percentage of desired energy savings.

10. An energy management system for controlling Heating Ventilation and Cooling equipment wherein the system includes a control apparatus and an energy management program used in controlling the heating ventilation and cooling equipment, the system further comprising:
A) a settings storage apparatus storing a plurality of energy management profiles, each energy management profile specifying a significant number of preconfigured energy management control setting values, the energy management control settings values being used by the energy management program for controlling a plurality of features of the energy management program;
B) a selection apparatus enabling a user of the energy management system to select at least one selected energy management profile; and,
C) the control apparatus being operatively coupled to the selection apparatus and responsive to the selected energy management profile to control the Heating Ventilation and Cooling equipment.

11. The energy management system of claim 10) wherein the number of preconfigured energy management profiles is five or more.

12. The energy management system of claim 10) wherein the selection of the preconfigured energy management profile is facilitated by utilizing labels or names of the profile that identify to a user a degree of aggressiveness in achieving energy savings.

13. The energy management system of claim 10) wherein the selection of the preconfigured energy management profile is facilitated by presenting the profiles for selection in an order defined by estimated energy savings.

14. The energy management system of claim 10) wherein the system operatively couples to an internet communication network that enables alteration of the preconfigured energy management control setting values by downloading new energy management control setting values from the internet network.

15. The energy management system of claim 10) wherein the selection apparatus generates a menu screen for displaying a listing providing labels for each of the preconfigured energy management profiles.

16. The energy management system of claim 10) wherein the selection apparatus provides for choosing the selected energy management profile based upon user input specifying a level or percentage of energy savings.

17. The energy management system of claim 10) wherein the selection apparatus utilizes other relative information, such as geographic area, in determining the selection of the selected preconfigured energy management profile.

18. A method of controlling Heating Ventilation and Cooling (HVAC) equipment comprising the steps of:
A) empirically determining a plurality of sets of energy management control settings values, each set of energy management control settings values selected to achieve a different level of energy savings in control of the HVAC equipment;
B) storing the result produced in step A) into a memory storage device;
C) providing an interface facility for enabling a user to make a selection of one set of energy management control settings values;
D) in response to the selection in step C) accessing the selected one set of energy management control settings values from the memory storage device and utilizing a plurality of control setting values from the selected set of energy management control settings values in controlling operation of the HVAC equipment.

19. The method of claim 18) wherein the interface facility presents the user with estimated levels of energy savings for one or more of the plurality of sets of energy management control settings as an aid in making the selection.

20. The method of claim 18) wherein the interface facility presents the user with the plurality of sets of energy management control settings ordered according to estimated energy savings as an aid in making the selection.
